(19) United States
(12) Patent Application Publication
(10) Pub. No.: US 2003/0193018 A1
(43) Pub. Date: Oct. 16, 2003

(54) Optical integrated circuit element package and method for making the same

(76) Inventors: Su Tao, Kaohsiung (TW); Kuo Chung Yee, Taipei (TW); Jen Chieh Kao, Kaohsiung (TW); Chih Lung Chen, Fengshan City (TW); Hsing Jung Liau, Kaohsiung (TW)

Correspondence Address: LOWE HAUPTMAN GILMAN & BERNER, LLP, Suite 310, 1700 Diagonal Road, Alexandria, VA, 22314, US

(21) Appl. No.: 10/352,919

(22) Filed: Jan. 29, 2003

(30) Foreign Application Priority Data
Apr. 15, 2002 (TW) 091107806

(51) Int. Cl. H01J 5/02

(52) U.S. Cl. 250/239

(57) ABSTRACT

An optical integrated circuit element package comprises a lead frame, a chip, a wall, and a transparent cover. The lead frame has a plurality of leads substantially coplanar and defining a central region, and a die pad is disposed on the central region. The chip is disposed on the die pad and has an optical integrated circuit element and a plurality of pads which are electrically connected to the plurality of leads by a plurality of bonding wires. The height of the wall is higher than the chip and the plurality of bonding wires, and the wall has an extending portion hermetically extending between the die pad and the plurality of leads. The extending portion is substantially coplanar with the leads, and the plurality of leads are exposed out of the lower surface of the extending portion. The transparent cover hermetically covers the wall.

### BACKGROUND OF THE INVENTION

1. Field of the Invention

The present invention generally relates to an optical integrated circuit element package, and more particularly relates to a quad flat non-leaded (QFN) package with an optical integrated circuit element.

2. Description of the Related Art

In typical photo-electric applications, a photo-electric element in the form of an integrated circuit chip, i.e., the image sensor chip, is practically protected in a package provided with an opening sealed by a transparent cover from physical damage and contamination in the surrounding environment. Therefore, the image sensor chip can detect the optical signals in accordance with the optical principle.

For example, the image sensor chip is generally mounted by an adhesive layer onto a cofired ceramic substrate with protruding pins. Typically, the adhesive layer must undertake an curing process to securely mount the image sensor chip on the ceramic substrate. After-wire bonding and window sealing processes, the pins are cut to desired length and formed into desired configuration to complete the whole packaging process.

In the window sealing process, a molding compound is typically dispensed or molded around the image sensor chip on the substrate. Then, a transparent cover is placed onthe molding compound for sealing the image sensor chip within a space defined by the substrate and the cover. For example, U.S. Pat. No. 5,811,799 entitled “Image sensor package having a wall with a sealed cover” issued to Wu on Sep. 22, 1998, disclosed an image sensor package wherein an image sensor chip is packaged on the ceramic substrate having a pre-molded wall. However, the processes required in the above patent are relatively expensive, and the package formed thereform is also relatively bulky.

In recent years, in order to catch up with rapidly downsizing of electronic units, it has become increasingly necessary to assemble semiconductor components for those electronic units at more higher density. Correspondingly, sizes and/or thicknesses of the semiconductor components such as resin-molded semiconductor devices in which the semiconductor chip, lead frame and so on are molded with a resin encapsulant have also been noticeably reduced. Examples of resin-molded semiconductor devices accomplishing these objects include a so-called “quad flat non-leaded (QFN)” package. From the QFN package are eliminated outer leads which usually protrude laterally out of a conventional package. Instead, external electrodes to be electrically connected to a motherboard are provided on the backside of the QFN package.

Therefore, there exists a need for optical device package manufacturers to provide an optical element QFN package with small packaging size and low manufacturing cost, as well as to provide semiconductor component with high-density fabrication.

### SUMMARY OF THE INVENTION

It is an object of the present invention to provide an optical integrated circuit element package providing a smaller packaging size and lower manufacturing cost.

It is another object of the present invention to provide a method for making optical integrated circuit element package, wherein the package provides a smaller packaging size and lower manufacturing cost.

In order to achieve the objects mentioned hereinabove, the present invention provides an optical integrated circuit element package comprising: a lead frame having a plurality of leads substantially coplanar and defining a central region, a die pad disposed on the central region; a chip disposed on the die pad and having an optical integrated circuit element and having a plurality of pads electrically connected to the plurality of leads by a plurality of bonding wires, a wall of which the height is higher than the chip and the plurality of bonding wires, the wall having an extending portion hermetically extending between the die pad and the plurality of leads, the extending portion substantially coplanar with the leads, the plurality of leads exposed out of the lower surface of the extending portion; and a transparent cover hermetically covering the wall.

The present invention further provides a process for making a package wherein the process comprises following steps: providing a matrix frame with a plurality of lead frames, each one of the plurality of lead frames having a plurality of leads substantially coplanar and defining a central region, and a die pad disposed on the central region; molding a wall having an extending portion hermetically extending between the die pad and the plurality of leads, the extending portion substantially coplanar with the leads, the plurality of leads exposed out of the lower surface of the extending portion; providing a plurality chips disposed on each die pad, each chip having a plurality of pads; electrically connecting the chip to the plurality of leads by a plurality of bonding wires; hermetically coving the wall of the respective lead frames; and dicing the matrix frame into individual package.

As mentioned above, the optical element package according to the present invention is a quad flat non-leaded (QFN) package. The QFN package has pre-molded wall and utilizes typical lead frame instead of the expensive bisma-leimide triazine resin (BT) substrate for accomplishing the purposes of smaller package size, especially lower profile, and lower manufacturing cost. Further, the package provides signal transmission with shortest paths for better electrical performance due to the elimination of external leads.

### BRIEF DESCRIPTION OF THE DRAWINGS

Other objects, advantages, and novel features of the invention will become more apparent from the following detailed description when taken in conjunction with the accompanying drawings.

FIG. 1 is a top plan view of an optical element package according to a preferred embodiment of the present invention.

FIG. 2 is a cross-sectional view of the optical element package taken along the line 2-2 in FIG. 1.

FIG. 3 is a cross-sectional view of the optical element package taken along the line 3-3 in FIG. 1.

FIG. 4 is an enlarged view of cross-sectional region 4 in FIG. 2.

FIG. 5 is a top plan view of a matrix frame with lead frames of an optical element package according to a preferred embodiment of the present invention.

FIG. 6 is a cross-sectional sketch view of the wall molding process of the optical element package according to a preferred embodiment of the present invention.

FIG. 7 is a cross-sectional sketch view of the processing process of the optical element package according to the present invention.

### DESCRIPTION OF THE PREFERRED EMBODIMENT

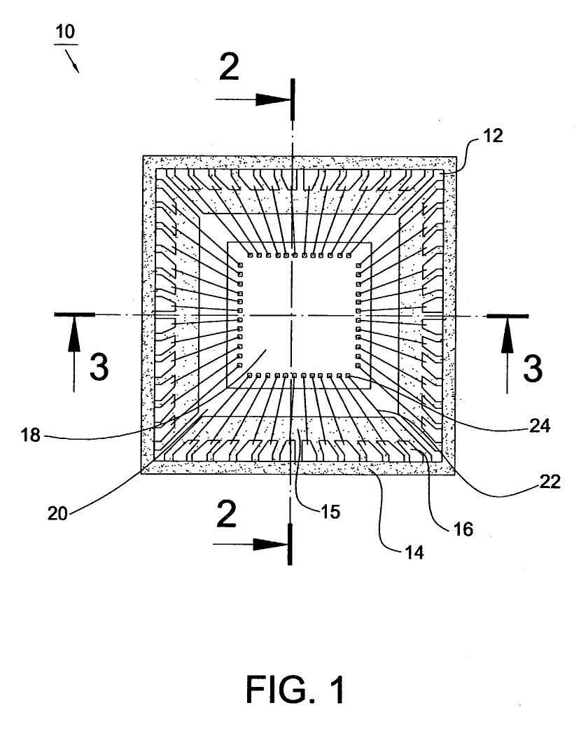

Now referring to FIG. 1 to 3, an optical element package 10, according to a preferred embodiment of the present invention, mainly comprises a lead frame 12 and a chip 18 having a plurality of pads 24. The lead frame 12 is generally made of metals such as copper and aluminum alloy, and has a die pad 20 for disposing the chip 18 thereon and a plurality of leads 16 for being electrically connected to the plurality of pads 24 of the chip 18 by wire bounding through a plurality of bonding wires 22. The active surface of the chip 18 has optical element such as optical sensors for converting between the optical signals and the electrical signals.

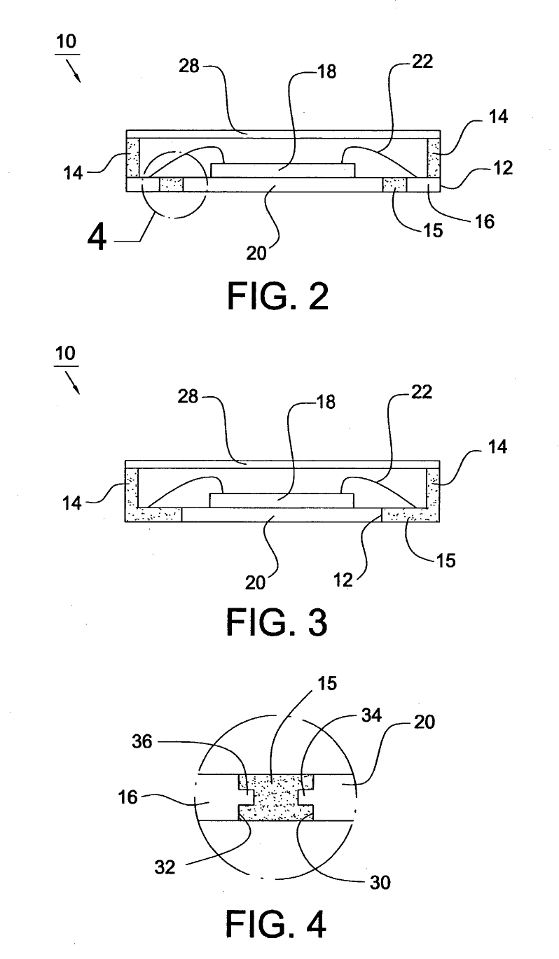

Now referring to FIG. 2 and FIG. 3, the optical element package 10 further comprises a wall 14 and an optically transparent cover 28. The wall 14 is surrounding the die pad 20 and the height of the wall is higher than that of the chip 18 and the plurality of bonding wires 22. The cover 28 hermetically covers the wall and is optically transparent such that the optical signals, such as visible lights or lasers and so on, can pass through the optical package 10 to reach the chip 18.

It should be noted that the wall 14 can be formed by processing processes such as injection or transfer molding process and so on. As mentioned above, the wall has an extending portion 15 extending between the plurality of leads 16 and the die pad 20 whereby the extending portion 15 hermetically seals the bottom of the optical element package 10. Further, as shown in FIG. 4, one skill in the art will appreciate that a edge 30 of the die pad 20 and a edge 32 of the leads 16 are inclined or further comprise mechanical lock 34, 36 respectively whereby the extending portion 15 can be fixedly mounted between the die pad 20 and the leads 16. The interfaces between the edge 30 of the die pad 20 and the edge 32 of the leads 16 and the extending portion 15, can be provided with UV epoxy for enhancing the resistance of moisture permeability.

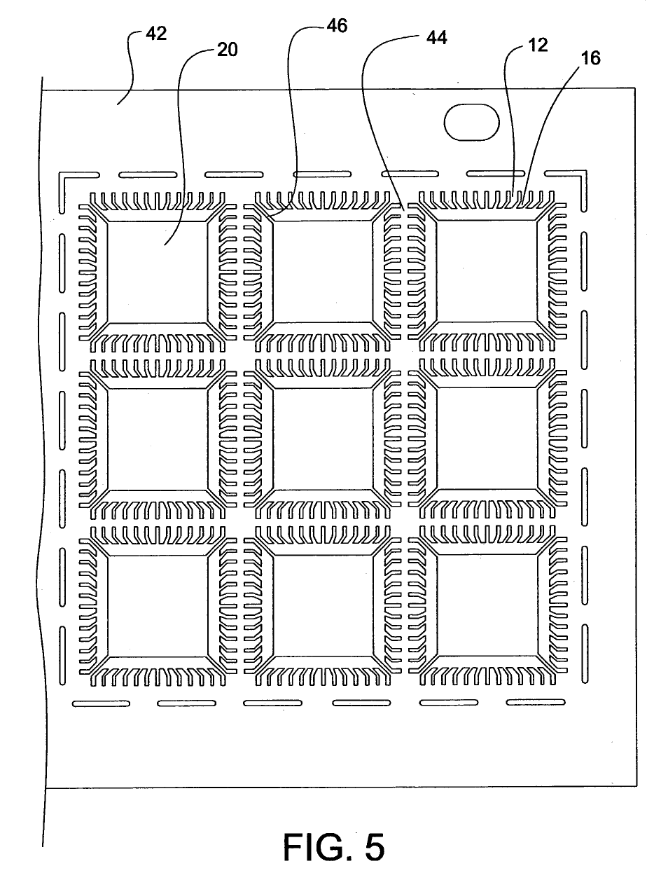

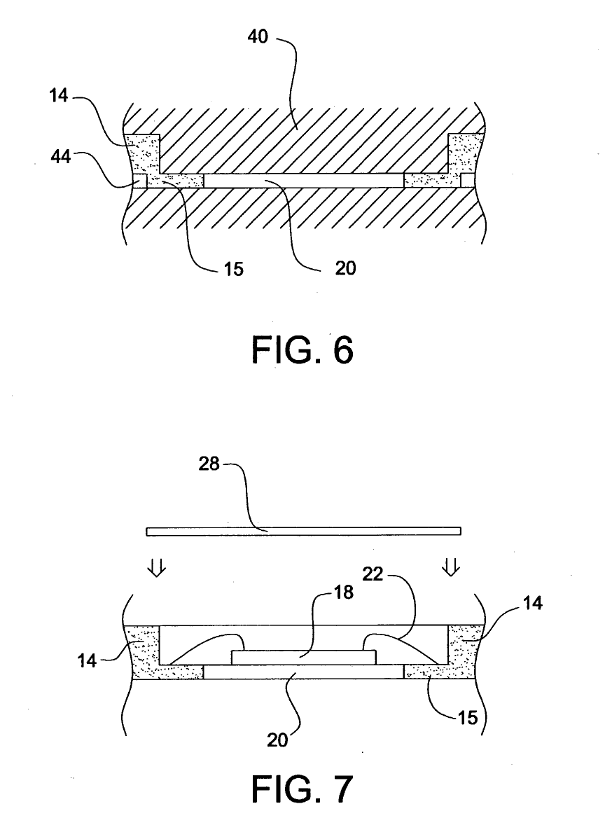

The present invention also provides a process for making the optical element package 10. Now referring to FIG. 5, the process according to the present invention, first, provides a matrix frame 42 made of metal and provided with lead frames 12 thereon. The matrix frame 42 has frames 44 connected to the plurality of leads and has supporting tie bars 46 connected to the die pad 20. As also show in FIG. 6, the lead frame 12 is placed into a casting mold 40 so as to mold the wall 14 and the extending portion 15.

Now referring to FIG. 7, the chip 18 is mounted on the die pad 20 by silver epoxy, and the plurality of pads 24 of the chip 18 is connected to the plurality of leads 16 by wire bounding through a plurality of bonding wires 22. Then, the cover 28 is covered over the top of the wall 14 by means of sealing compounds such as UV epoxy, and then through means of the dicing process, the optical element package of the present invention can be formed. It should be noted that the cover 28 is made of transparent materials with high rigidness such as transparent polymer, glass, quartz, and sapphire so that the cover is typically coved over the top of the wall by an individual cover. However, the cover 28 also can be an integrated form for covering the entire matrix frame 12 and then forming the individual package 10 by means of the dicing process.

As mentioned above, the optical element package according to the present invention is a quad flat non-leaded (QFN) package. The QFN package has pre-molded wall and utilizes typical lead frame instead of the expensive bisma-leimide triazine resin (BT) substrate for accomplishing the purposes of smaller package size, especially lower profile, and lower manufacturing cost. Further, the package provides signal transmission with shortest paths for better electrical performance due to the elimination of external leads.

While the foregoing description and drawings represent the embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components. The presently disclosed embodiments are therefore to be considered in all respects as illustrative and not restrictive, the scope of the invention being indicated by the appended claims and their legal equivalents, and not limited to the foregoing description.

What is claimed is:

1. An optical integrated circuit element package, comprising:
a lead frame having a plurality of leads substantially coplanar and defining a central region, and a die pad disposed on the central region;
a chip disposed on the die pad and having an optical integrated circuit element and a plurality of pads electrically connected to the plurality of leads by a plurality of bonding wires;
a wall of which the height is higher than the chip and the plurality of bonding wires, the wall having an extending portion hermetically extending between the die pad and the plurality of leads, the extending portion substantially coplanar with the leads, and the plurality of leads exposed out of the lower surface of the extending portion; and
a transparent cover hermetically covering the wall.

2. The optical integrated circuit element package according to claim 1, wherein the edge of the die pad and the edge of the leads further comprise a plurality of mechanical lock for fixing the extending portion.

3. The optical integrated circuit element package according to claim 1 further comprising UV epoxy disposed on the interfaces between the die pad and the leads and the extending portion for enhancing the resistance of moisture permeability.

4. The optical integrated circuit element package according to claim 1, wherein the material of the cover is selected from the group consisting of the transparent polymer, glass, quartz, and sapphire.

5. A method for making an optical integrated circuit element package, comprising the following steps:
providing a matrix frame with a plurality of lead frames, each one of the plurality of lead frames having a plurality of leads substantially coplanar and defining a central region, and a die pad disposed on the central region;
molding a wall having an extending portion hermetically extending between the die pad and the plurality of leads, the extending portion substantially coplanar with the leads, the plurality of leads exposed out of the lower surface of the extending portion;
providing a plurality chips disposed on each die pad, each chip having a plurality of pads;
electrically connecting the chip to the plurality of leads;
hermetically coving the wall of the respective lead frames; and
dicing the matrix frame into individual package.

6. The method according to claim 5 further comprising the step: disposing the UV epoxy on the interfaces between the die pad and the leads and the extending portion for enhancing the resistance of moisture permeability.

7. The method according to claim 5, wherein the step of molding the wall is achieved by transfer molding process.
